(19) United States
(12) Patent Application Publication
(10) Pub. No.: US 2006/0204036 A1
(43) Pub. Date: Sep. 14, 2006

(54) Method for intelligent video processing

(76) Inventor: Dean Huang, Gordon (AU)

Correspondence Address: DEAN HUANG, 36 CECIL ST, GORDON, NSW 2072, AU

(21) Appl. No.: 11/360,731

(22) Filed: Feb. 24, 2006

(30) Foreign Application Priority Data
Mar. 9, 2005 (AU) 2005901126

(51) Int. Cl. G06K 9/00; H04N 5/225; G06K 9/36; H04N 5/14

(52) U.S. Cl. 382/103; 382/107; 382/291; 348/699; 348/169

(57) ABSTRACT

The present invention discloses a method that integrates space and time analysis methods in intelligent video processing, and complements their advantages. The present invention discloses a method for implementing intelligent video detection. The method comprises pre-processing video frames, estimating foreground objects, generating motion signals, and using a fuzzy system to offer feedback signals to the previous processes, in order to adaptively improve their performance. The method integrates multiple functions, e.g. object tracking and suspicious-object detection into a common framework. In addition, the method offers other benefits such as intelligent background update.

### CROSS-REFERENCE TO RELATED APPLICATIONS

This application claims the benefit of Australian Provisional Patent Application 2005901126 (filed Mar. 9, 2005), to Australian Patent Office, by the present inventors.

### FEDERALLY SPONSORED RESEARCH

Not applicable

### SEQUENCE LISTING OR PROGRAM

Not applicable

### BACKGROUND OF THE INVENTION

1. Field of Invention

This invention relates to the fields of intelligent video processing, specifically to intelligent visual surveillance or automated surveillance system.

2. Background of the Invention

FIG. 1 shows a general procedure of visual detection and tracking system in the prior art (Elgammal et al., 2002, Venetianer et al.). The general procedure has three major processes: background estimation (or modeling) 30, motion detection 32 and tracking 34. In the prior art, a single frame is compared with a running statistical average of the intensity of each pixel (Collins et al., 2001). However, a single frame is not preferable to tell if an object is moving or not. This defect contributes to many false alarms. FIG. 1 also reveals that signals are sent in a single direction only. Even though there are some simple mechanisms in adjusting voting weights of predetermined statistical models (Stauffer et al., 2000), the prior art lacks fundamental ability to make use of valuable information across all the processes. In addition, errors (false alarms) in early process will propaganda to later process.

FIG. 2 shows a typical Gaussian model used in prior art (Elgammal et al., 2000). A Gaussian distribution 40 is estimated from a series of frames and the Gaussian model can be built for each pixel. Then a single predetermined threshold 42 is used for the entire scene to decide if a pixel falls in background or foreground. f(i) is the intensity value of a pixel in frame i and M is the mean of all the intensities from these frames. In this specification, color information is considered as comprising of multiple intensities, i.e. R, G and B. The binary classification of foreground and background forms a probability map. Thus many pixels may be falsely classified. This approach is not robust with many moving objects or objects moving slowly. Furthermore, the techniques in prior art will fail in many practical situations, such as change of light intensity.

Another significant drawback of the prior art (e.g. Venetianer et al., U.S. Patent Application 20040027242) is the over dependency on time analysis or detection methods, as explained later. As in Venetianer et al. 2004, the video detection has a number of steps: pixel-level background modeling, foreground detection and tracking, and object analysis. All the steps depend on buildup of pixel statistics that is generated from a number of history frames. If for some reasons (e.g. camera shaking or PTZ movement), the pixel statistics become unstable, then the video detection will be shut down (Collins et al. 2001). Obviously, if the camera continuously shakes or moves, then the video detection will not be able to work at all. Therefore, the methods heretofore known suffer from a number of disadvantages, which include:
(a) A single frame is compared with a running statistical average in deciding foreground.
(b) Signals are sent in a single direction only, thus the motion of objects is not utilized effectively in detecting objects themselves.
(c) A single threshold is used for the entire scene in classifying foreground and background. The threshold is usually predetermined.
(d) The system generates many false alarms and is not robust.
(e) Overly dependent on time analysis methods.

### BACKGROUND OF INVENTION—OBJECTS AND ADVANTAGES

The present invention defines a method that uses a feedback model that is able to adaptively self-adjust object estimation and detection.

The present invention also discloses a method that integrates space and time analysis methods in intelligent video processing and automated surveillance system.

Accordingly, several objects and advantages of this invention are:
(a) Multiple frames are compared with a running statistical average in deciding foreground.
(b) Signals are sent in both directions, i.e. the motion of objects becomes a useful clue in detecting objects themselves.
(c) Object or foreground estimation is adaptively improved.
(d) The system is more robust.
(e) The system can perform multiple functions within a common framework, such as tracking moving objects and detecting unattended suspicious objects.
(f) The system integrates space and time analysis detection in intelligent video processing, and complements their advantages.

Thus, the systems disclosed in the present invention are more intelligent and effective than what are available in the prior art.

Still other objects and advantages will become apparent from a consideration of the ensuing description and drawings.

### SUMMARY

The present invention discloses a method for implementing intelligent video detection. The method comprises pre-processing video frames, estimating foreground objects, generating motion signals, and using a rule-based system to offer feedback signals to the previous processes, in order to adaptively improve their performance. The rule-based system is preferably a fuzzy system. The method integrates multiple functions, e.g. object tracking and suspicious-object detection into a common framework. In addition, the method offers other benefits such as intelligent background update. The present invention also discloses a method that integrates space and time analysis or detection methods in intelligent video processing and automated surveillance system, and complements their advantages.

### DEFINITIONS

In describing the invention, the following definitions are applicable throughout (including above).

A “computer” refers to any apparatus that is capable of accepting a structured input, processing the structured input according to prescribed rules, and producing results of the processing as output. Examples of a computer include a computer; a general-purpose computer; a supercomputer; a mainframe; a super mini-computer; a mini-computer; a workstation; a microcomputer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” refers to any storage device used for storing data accessible by a computer. Examples of a computer-readable medium include a magnetic hard disk; a floppy disk; an optical disk, like a CD-ROM or a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include software; code segments; instructions; computer programs; and programmed logic. Software of intelligent systems may be capable of self-learning.

A “unit” or “module” refers to a basic component in a computer that performs a task or part of a task. It can be implemented by either software or hardware.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include an internet, such as the Internet; an intranet; a local area network (LAN); a wide area network (WAN); and a combination of networks, such as an internet and an intranet.

“Video” refers to motion pictures represented in analog and/or digital form. Examples of video include television, movies, image sequences from a camera or other observer, and computer-generated image sequences. These can be obtained from, for example, a live feed, a storage device, an IEEE 1394-based interface, a video digitizer, a computer graphics engine, or a network connection.

“Video processing” refers to any manipulation of video, including, for example, compression and editing.

A “frame” refers to a particular image or other discrete unit within a video. An “image” also refers to a frame.

### DRAWINGS—FIGURES

FIG. 1 shows a general procedure of visual detection and tracking system in the prior art.

FIG. 2 shows a typical Gaussian model used in prior art.

FIG. 3 shows a general procedure of the present invention.

FIGS. 4A and 4B show an example of detecting stationary and moved objects from different frames.

FIG. 5 shows an example that an additional signal is added to motion signal from foreground object estimation.

FIG. 6 shows an example of dynamically determining threshold based on the distinct difference of the probability values.

FIG. 7 shows a positive-feedback scenario that can speed up overall processing and also reliably detect edge.

FIG. 8 shows a general system structure that uses complemental analysis methods.

FIG. 9 illustrates a typical section of operation that makes use of the structure in FIG. 8.

FIG. 10A and FIG. 10B show an example of using space analysis methods in intelligent video analysis and automated surveillance system.

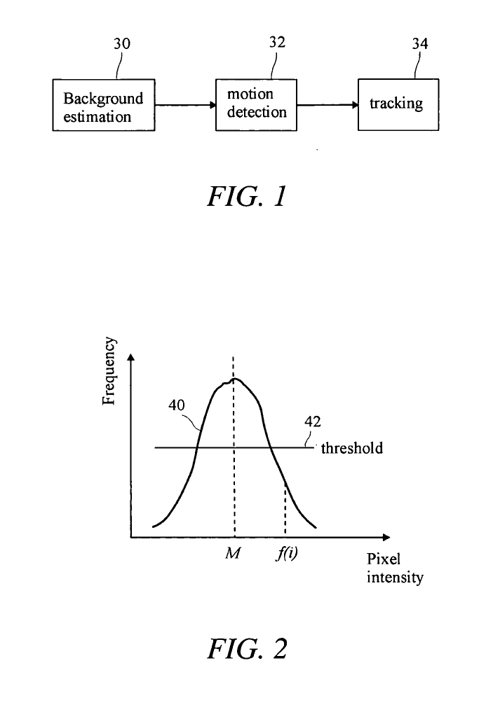

### DESCRIPTION OF THE PREFERRED EMBODIMENT

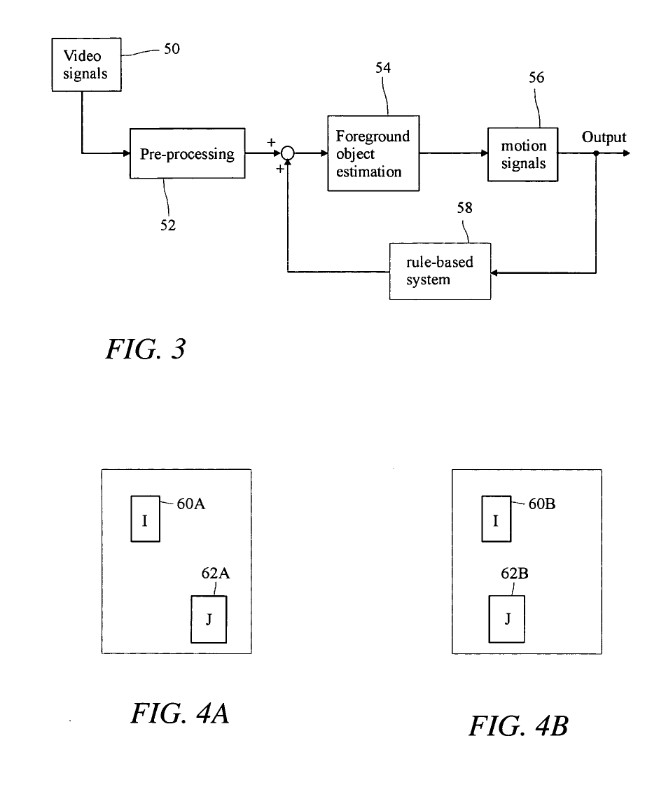

FIG. 3 shows a general procedure of the present invention. Video signals 50 are sent to a functional module 52 that pre-processes video frames. In this specification, the purpose of pre-processing images is to extract shape clues of foreground objects. In the prior art, region-based and contour-based methods can generate shape information. A preferred method for region-based method is background subtraction, which builds a running statistical model of the intensity at each pixel. Methods of background subtraction are described in the references listed at the end of this specification, e.g. Elgammal et al. (2000). Gradient or Laplacian-type edge detection can be used in getting the edge or contour (refer to Bovik, 2000 for technical details). Preferably region-based and contour-based methods are combined in generating shape information, since the combination may offer a robust estimation in complex environments. One scenario of the combination is disclosed in the following part of this specification. Foreground objects are estimated after pre-processing images.

Foreground object estimation 54 in the present invention is dramatically different from those in prior art. The present invention doesn't use a predetermined threshold while processing each frame. By using feedback information, the probability estimation of pixels for foreground objects can be adaptively improved. The detail will be disclosed in the following description.

A probability is used to represent a likelihood of a pixel belonging to an object. The probability can initially be estimated as:
P(i)=α(f(i)−M) (Equation 1)
where probability P(i) is used to represent the likelihood of a pixel i belonging to a foreground object. f(i) is the intensity value of a pixel in frame i and M is the mean of all pixel intensities from many frames, both shown in FIG. 2. In the procedure shown in FIG. 3, P(i) will be adaptively modified as disclosed in the following.

Motion signals 56 can be generated from different frames. Motion signals 56 in the present specification mean differences or moving parts among frames, as described in the example shown in FIGS. 4A and 4B. From FIGS. 4A to 4B, object I 60A is stationary since its matched object 60B is at the same position. But object J 62A is moved to 62B. Thus, object J 62A generates a motion signal. Object I and J in FIGS. 4A and 4B can be matched by using intensity matching, or color/texture matching, or size/aspect ratio matching, or other intuitive rules. Motion signals in the present invention can be generated from many consecutive frames, or frames at some time intervals, or differences among averaged frames.

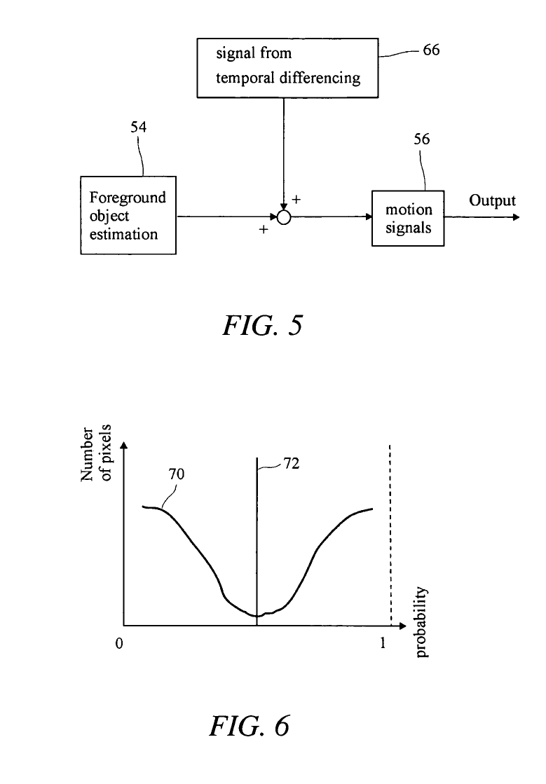

To enhance system stability, external motion signals can be used in addition to those generated from the previous processes in FIG. 3. FIG. 5 shows an example that an additional signal from temporal differencing 66 is also considered in addition to motion signal 56 from foreground object estimation 54. The ‘+’ signs in FIG. 5 can mean any method to weight the motion signals together, instead of simple addition operation. Temporal differencing is a simpler form of estimating foreground, in which frames separated by a constant time are compared to find regions that have changed. Motion signals in the present invention can also be generated from non-visual means, such as ultrasound, GPS, etc. A significant benefit of taking the motion signals in the loop in FIG. 3 is providing a valuable and effective means of object estimation.

The motion signals 56 can then be sent to a rule-based system 58 which is preferably a fuzzy system. A fuzzy system in the loop can be considered as a controller. A fuzzy controller comprises a rule-base, an inference mechanism a fuzzification interface and a defuzzification interface (Passino et al. 1998). In the present invention, fuzzy rules in the rule-base can be pre-set or dynamically learnt. For example, a rule can be set as:

Rule A:

If motion signal of an object is small Then increase probability of its pixels a small amount.

In Rule A and other rules in this specification, ‘probability’ can be the result return by Equation 1 or similar variations, and ‘small’ can be described by a membership function. The general procedure of setting membership functions, obtaining an output from the inputs and the rules is described in a reference at the end of this specification, i.e. Passino et al. 1998. The prior art can provide many methods in detecting pixels inside an object, e.g. vertical scan, horizontal scan or combination of them (Bovik, 2000).

The feedback loop shown in FIG. 3 can be continuously executed. For example, a probability value calculated in frame i can be adaptively modified at frame i+1, i+2 and so on, from motion signals obtained from the frames. Therefore, continuous application of Rule A will

(a) gradually increases the probability of pixels that belong to moving objects.

(b) keeps constant the probability of pixels of objects that are stationary.

After Rule A is executed several iterations, the system will be more confident about moving objects since pixels in the moving objects will have distinct probability values. Then a dynamically determined threshold can be applied to determined foreground objects. An example is shown in FIG. 6. Curve 70 represents a probability profile after several iterations of the feedback procedure. The right part of curve 70 can mostly represent probability values of foreground objects. The left part can mostly represent probability values of background and possibly other less mobile objects. A dynamically determined threshold 72 can be determined in real-time based on the distinct difference of the probability values. For example, threshold 72 can be found by vertically scanning probability curve 70 and searching for a minimum value. After the determination and application of the threshold, the procedure in FIG. 3 can be run in a simpler form, e.g. using a smaller number of iterations. Detection of significant event (e.g. change of object shapes, speed) can restore the procedure to a larger number of iterations. Therefore, the system can intelligently adjust required computing-resources and reliably track/detect objects.

Thus in the present invention, the motion of objects becomes a significant clue in dynamically detecting objects themselves. The motion of objects is used to adaptively improve object estimation. Therefore, the present invention is dramatically different from prior art, which uses a simple threshold to decide foreground objects at each frame. In other words, object estimation or detection is dynamic and intelligent in the present invention.

While Rule A creates a positive feedback for moving objects, positive feedback can also be applied to newly introduced stationary objects. For example, another rule can be set as:

Rule B:

If a new object remains stationary for a short period Then increase probability of its pixels a small amount proportional to the period.

Rule B will modify probability of newly arrived objects. New objects can be detected by detecting changed histogram or by using the Gaussian model shown in FIG. 2. Rule B will not significantly affect initial false-detections that are generated from transient variations such as random changes of light intensity. Thus, Rule B can gradually increase the probability values of stationary objects. If the probability of pixels reaches a higher level, we are more certain that an object has remained for a longer time. Thus, another (possibly dynamically set) threshold can be set to trigger alarms. An application of this technique is that unattended and suspicious objects will automatically become outstanding. Thus, this technique can be used in detecting suspicious objects left in public places, e.g. bombs in train stations or airports.

Multiple visual tasks (such as object tracking and suspicious-object detection) can be integrated in a common framework. Functional units that implement the above Rule A and Rule B can be run simultaneously in the same computer, or the same application. Thus the present invention has substantial advantages over prior art.

According to the spirit of the present invention, the feedback model is controlled by a fuzzy controller. Thus, the system can adaptively search for previous frames, by using rules such as

Rule C:

If a new object remains stationary and becomes hidden (obscured) for a period of time Then increase probability of its pixels a amount proportional to the hiding time, after the object re-appears.

The object before and after the obscured period can be matched by many methods. These methods include location matching, intensity matching, or color/texture matching, or size/aspect ratio matching, other intuitive rules, or any combination of them.

Thus, even if a suspicious object is temporarily hidden behind other objects such as moving people, it can be still remembered by the system. The rule can be applied for complete or partial hiding of objects. In a surveillance system with multiple security cameras, suspicious objects may not be hidden (obscured) simultaneously in all cameras. In fact, information can be shared among multiple cameras (Collins et al., 2001) and 3D positions of objects may thus be built up (Lee et al. 2000). Thus multiple cameras can offer valuable clues about positions and motion of objects. All scenarios described in this specification can make use of the multiple cameras. To take an analogy, the multiple cameras will act as multiple eyes of the security systems and the present invention offers an information-processing brain.

In the prior art, update for the statistical model of background is not adaptive, instead simple methods (e.g. selective/blind update) is used in prior art. Thus, if a tracked object stops for a while, it will become part of background. However, in practical applications, it is often desired that objects can be tracked for a long time. In the present invention, fuzzy rules can be set to keep on tracking the objects even if they stop. In fact, by using Rule A alone, pixels of a previously moved object will have higher foreground probability than other stationary or less mobile objects, even if it stops in the middle of motion. Thus, the present invention has the advantage of intelligent background update.

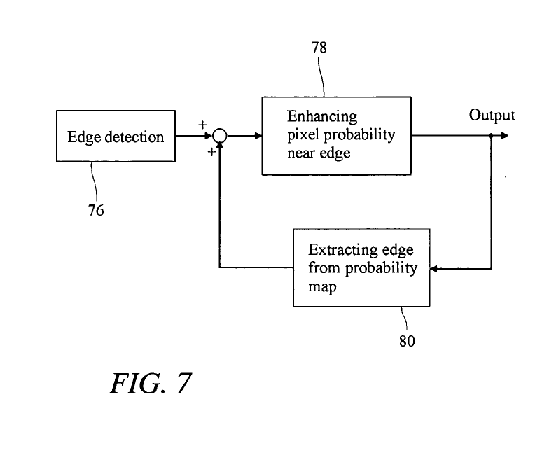

The feedback method is not necessarily executed for every pixel. Instead, only probabilities of pixels near the edge of objects may need to be adaptively enhanced. FIG. 7 shows a positive-feedback scenario that can speed up overall processing and also reliably detect edge. First, edge is detected 76. Then the probabilities of pixels near the edge are enhanced 78 using the feedback method. Then an edge is extracted 80 from the probability map and can be used in enhancing the original edge information. The probability map in this process can be either binary or grayscale. Edge can be found from the probability map by using Gradient or Laplacian-type edge detection (Bovik, 2000).

After the edge is enhanced, pixels inside an object can be automatically determined by horizontal/vertical scan. For the prior art, probability estimation of foreground is based on pixels, e.g. Elgammal et al. (2000). Thus, another advantage of the present invention is that it offers an object-based framework

The present invention also discloses a method that integrates space and time analysis methods in intelligent video processing and automated surveillance system.

Time analysis methods are analysis methods that are based on a series of image frames, which are caught at different time. The time analysis methods are so named in this patent specification since they generally emphasize more on time clues than on space clues. Intelligent video analysis and automated surveillance in the prior art tends to depend on time analysis methods, especially in the crucially important step of pixel level background modeling (or estimation). For example, in Venetianer et al. 2004, pixel values and their statistics are obtained from several frames.

A space analysis method makes use of space clues that can or may require only a single frame. The space analysis methods are so named in this patent specification since they tend to emphasize more on space clues than on time clues. An example of space analysis methods is the histogram since a histogram can be obtained from a single image. In Venetianer et al. 2004, histogram was used in determining the size of objects of interest, which is a procedure before the important steps of background modeling and foreground detection. Histograms have also been used in thresholding and segmenting image into (multiple) foreground and background objects, as in Gonzalez et al. 2002. The present invention, however, uses histogram (space analysis methods in general) and time analysis methods as integral parts in modeling background and detecting foreground objects.

Thus, time analysis methods and space analysis methods have different characteristics. Table 1 summarizes some of the significant differences.

As shown in Table 1, time analysis methods and space analysis methods have characteristics that can mutually complement each other. The complementarity constitutes the basic principle of a part of the present invention.

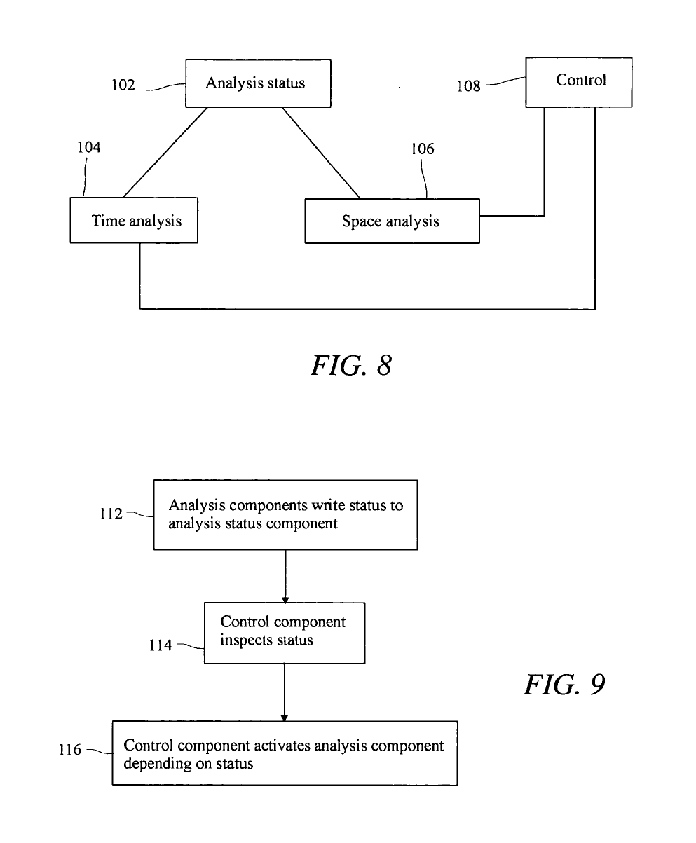

FIG. 8 shows a general system structure that uses the complemental analysis methods. FIG. 9 illustrates a typical section of operation that makes use of the structure.

TABLE 1

| | | Required | |
|---|---|---|---|
| | Primary Clues | Frames | Application Strength |
| Time Analysis | time | multiple | background modeling over |
| Methods | | | time |
| Space Analysis | space | single | thresholding and |
| Methods | | | segmenting a single image |

There are four components or subsystems in FIG. 8. Time analysis component 104 and space analysis component 106 can write their status to the analysis status component 102 (Step 112 in FIG. 9). For example, time analysis component 104 can detect the foreground pixels and then form connected components from the foreground pixels, techniques that are well known in the art. Thus, time analysis component 104 can write the foreground pixels and connected component to the analysis status component 102. The control component 108 then inspects the analysis status component 102 (Step 114 in FIG. 9). Depending on the status of analysis status component 102, control component 108 will decide to activate either time analysis component 104, or space analysis component 106, or both in an appropriate order (Step 116 in FIG. 9), whose examples will be given in this patent specification. Then the procedure from Step 112 to 116 can be repeated again if so required by applications.

For example, if the status of time analysis component 104 indicates the majority of image pixels are changed, the control component 108 can activate the space analysis component 106. The change of majority image pixels usually means a sudden camera movement or light change, etc, and the pixel statistics from a series of frames may become useless or error-prone. prone. In the prior art, e.g. Collins et al. 2001, detection algorithms temporarily shut down in such a situation. But in the present invention, space analysis component 106 can use only a single frame of image, whether there is sudden change or not. In other words, the present invention does not require statistics from a series of frames in order for intelligent video processing and automated surveillance to work. Space analysis component 106 can build a histogram from a single frame of image, then uses thresholding to segment the image into different objects.

The preferred method for thresholding and segmentation is thresholding on the HSI (hue, saturation, intensity) color space or its equivalence. An image is first converted to HSI format. Then histogram of the I (intensity) component is built and thresholded, which result in groups of the pixels and each group with similar intensity. Afterwards, histogram of the H (hue) component for each of the groups is built and thresholded, which result in groups of the pixels and each group with similar intensity and hue. Finally, histogram of the S (saturation) component for each of the groups is built and thresholded, which result in groups of the pixels and each group with similar intensity, hue and saturation. Image techniques for thresholding and segmenting a single component of the image are well known in the art, e.g. from Gonzalez et al. 2002. Connected components are then built from the final groups. A real object may possibly segmented into one or a number of connected components. In the latter case, the connected components that move approximately together can be grouped into one component during object tracking.

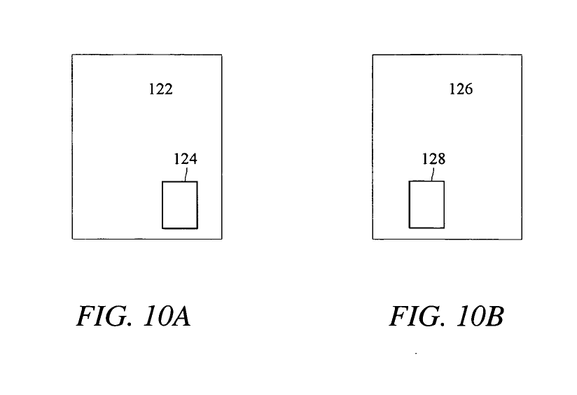

FIG. 10A and FIG. 10B show an example of using space analysis methods in intelligent video analysis and automated surveillance system. In FIG. 10A, a single frame of image is segmented into background 122 and foreground 124 by thresholding. In FIG. 10B, the background 126 and foreground 128 from another frame of image are segmented using the same technique. By using tracking techniques (or their equivalence) that are well known in prior art (e.g. Venetianer et al. 2004), we can track the segmented objects. In other words, we can determine if the moved foreground objects 124 and 128 in the two frames are actually the same object. Thus, it is possible to use space analysis methods alone in situations that prior art techniques will shut down.

Since time analysis methods are based on pixel statistics from several frames, there may be noise or inaccuracy presented in the results. Because space analysis methods use information that is different from time analysis methods, they can help to remove the noise and inaccuracy from time analysis methods, and vice versa. Therefore, space analysis methods can be conducted around detected foreground from time analysis methods in the above example. However, space analysis methods can also be applied to a whole image area if different applications so require.

Since time analysis methods and space analysis methods have complemental characteristics, they can mutually enhance each other while both are in operation. For example, if a human object is detected as belonging to foreground by time analysis methods. Then space analysis methods can be used to segment the image area around the detected foreground object. If different parts of the human object have different gray levels, colors or saturations, the space analysis methods can help to segment them into different objects, e.g. upper cloth, pants, feet, hands and the face. In Collins et al. 2001, object type classification and human motion analysis use only information such as the area, aspect ratio, center and local extreme points of blobs. In contrast, the present invention can generate information about components of distinctive intensity, hue and saturation, and their positions. In addition, the information can be obtained independently from that generates the blobs. Therefore, the present invention is able to offer a lot more useful information in object analysis, which is a step after background modeling, object detection and tracking. Thus the current invention can offer more solid foundation for object type classification and motion analysis.

The complementarity of time analysis methods and space analysis methods can be implemented in many other ways. I do not wish to be bound by the examples given in this specification.

Conclusion, Ramification, and Scope

The specification so far has described intelligent systems that process video signals. The basic techniques can also process other signals, patterns or media signals, e.g. audio signals, behavior signals, etc. The basic elements of the generic system comprise an object estimator, a motion estimator and a feedback system. The basic elements of the environment-based adaptive system comprise environment-based processing unit, and filters. Another important element of the system is the environment-based knowledge model. On one hand, the environment-based knowledge model can be set for different environment; on the other hand, the model can dynamically accumulate knowledge.

FIG. 3 illustrates a positive-feedback model that is used to enhance the object estimation using motion signals. Understandably, a negative-feedback model may also be used to neglect transient features (e.g. moving objects) and appropriate rules can be set for the negative-feedback model.

Rule A and Rule B in this specification are used in detecting moving and stationary objects. In fact, similar rules can be used in detecting less mobile objects, or objects that have unusual patterns of movement, e.g. path or speed. Rule C is described in dealing with object hiding, but the rule or similar variations can also be used in dealing with situations in which foreground (possibly moving) objects and background have similar colors. For example, if a foreground object has the same (or close) color with background from frame i to i+n, rules can be used in matching frame i−i with i+n+l, etc. Sudden change of detected foreground objects may indicate inability of differentiating foreground and background.

This patent specification predominantly focuses on tracking objects and surveillance systems. However, the disclosed technologies can be used as a solid foundation of more advanced application, such as behavior analysis of the tracking objects.

This patent specification predominantly uses pixels as an element in describing algorithms. However, the basic techniques can easily be applied to other elements, such as sub-images. All the algorithms described in the present invention can be run in a single computer or multiple computers.

The present invention has a number of significant advantages and benefits.
(a) Multiple frames are compared with a running statistical average in deciding foreground.
(b) Signals are sent in both directions, i.e. the motion of objects becomes a significant clue in dynamically detecting objects themselves.
(c) Probability values are gradually improved in deciding if objects are foreground.
(d) The system is more robust.
(e) The system can perform multiple functions within a common framework, such as tracking moving objects and detecting unattended suspicious objects.
(f) Systems are able to make use complementarity time and space analysis methods, in situations that prior art techniques shut down.
(g) Systems are able to offer more useful information for object analysis.

The foregoing describes only some embodiments of the present inventions, and modifications obvious to those skilled in the art can be made thereto without departing from the scope of the present invention.

### REFERENCES—Patents

Venetianer et al., “Video Tripwire”, U.S. Patent Application 20040027242.

### REFERENCES—Non-Patents

Elgammal et al., “Background and Foreground Modeling Using Nonparametric Kernel Density Estimation for Visual Surveillance”, Proceedings of The EEE, vol. 90, no. 7, pp. 1151-1163, (2002).
Elgammal et al., “Non-parametric Model for Background Subtraction”, in Proc. 6^{th} Eur. Conf. Computer Vision, vol. 2, Vienna, Austria, pp. 751-767, (2000).
Collins et al., “Algorithms for Cooperative Multisensor Surveillance”, Proceedings of The IEEE, vol. 89, no. 10, pp. 1456-1477, (2001).
Stauffer et al., “Learning Patterns of Activity Using Real-Time Tracking”, IEEE Transactions on Pattern Analysis and Machine Intelligence, vol. 22, no. 8, pp. 747-757, (2000).
Passino et al., “Fuzzy Control”, Addison-Wesley, California, (1998). Lee et al., “Monitoring Activities from Multiple Video Streams: Establishing A Common Coordinate Frame”, Transactions on Pattern Analysis and Machine Intelligence, vol. 22, no. 8, pp. 758-767, (2000).
Gonzalez et al., “Digital Image Processing, 2^{nd} Edition”, Prentice Hall, New Jersey, (2002).
Bovik (ed.), “Handbook of Image and Video Processing”, Academic Press, California, (2000).

I claim:

1. An intelligent signal processing system comprising: an object estimator, a motion estimator and a feedback system.

2. The system of claim 1, further comprising a pre-process system.

3. The system of claim 1, further comprising: means of feeding the output of said motion estimator to said feedback system; and means of feeding the output of said feedback system to said object estimator, whereby estimations of said object estimator and said motion estimator are modified.

4. The system of claim 1, wherein said feedback system comprises a rule-base.

5. The system of claim 4, wherein said feedback system is a fuzzy system.

6. The system of claim 1, further comprising means of integrating multiple functions.

7. The system of claim 6, wherein said functions comprising object-tracking and suspicious-object detection.

8. The system of claim 1, further comprising means of tracking moving objects.

9. The system of claim 1, further comprising means of detecting unattended suspicious objects.

10. The system of claim 9, wherein said objects are explosive.

11. The system of claim 1, further comprising means of intelligently update background.

12. An intelligent video processing system comprising: a time analysis component, a space analysis component, an analysis status component, and a control component.

13. A method of integrating space and time analysis methods in intelligent video processing, and complementing their advantages.
